(19) United States
(12) Patent Application Publication
(10) Pub. No.: US 2016/0112406 A1
(43) Pub. Date: Apr. 21, 2016

(54) AUTHENTICATION AND AUTHORIZATION IN AN INDUSTRIAL CONTROL SYSTEM USING A SINGLE DIGITAL CERTIFICATE

(71) Applicant: Schneider Electric Industries S.A.S., Rueil Malmaison (FR)

(72) Inventors: Evgeny Bugrov, Boston, MA (US); David Doggett, Andover, MA (US)

(21) Appl. No.: 14/518,527

(22) Filed: Oct. 20, 2014

(51) Int. Cl. H04L 29/06

(52) U.S. Cl. CPC H04L 63/0823

(57) ABSTRACT

Systems and methods for performing access control in an industrial control system are described. A first component of an industrial control system may be connected to a second component of the industrial control system. A digital certificate may be generated for the first component that includes both authentication information and authorization information associated with the first component. The first component may transmit the digital certificate to the second component, and the second component may extract the authorization information from the digital certificate. The second component may identify a set of access rights based on the authorization information extracted and authorize the first component to access the second component based on the set of access rights identified.

### BACKGROUND

Industrial control systems generally refer to control systems used in industrial applications such as industrial processing and production, public utility infrastructures, and private facility management. A distributed control system (DCS) is one type of industrial control system utilized to monitor and control multiple sub-systems that are each responsible for localized processing and production. In a DCS architecture, control elements might be hierarchically distributed through the system to coordinate operation of lower-level processing and production equipment. A supervisory control and data acquisition (SCADA) system is another type of industrial control system utilized to monitor and control remotely-located systems that might be distributed across wide geographic areas at multiple sites. In a SCADA architecture, a control center may collect data from the remotely-located systems and issue commands to control the equipment of these remotely-located systems.

Industrial control systems thus often include multiple interconnected components in signal communication with each other, either directly or across a network. The components of industrial control systems may exchange communications to report and collect data as well as to issue and receive commands. Industrial control systems may also utilize access control mechanisms to identify, authenticate, and authorize components requesting access to another component in the system. There are, however, drawbacks to the current options available for access control in industrial control systems.

An access control list (ACL) includes entries that identify an entity and the operations that entity is permitted to perform at a computing system or device. Industrial control systems, however, may include hundreds or even thousands of devices. As a result, adding a new device to the industrial control system may present a challenge where the identity and access rights of that new device must be distributed to hundreds and thousands of devices in order to update the ACL at each of those new devices.

In some networks, a centralized security server may handle authentication and authorization of the components in the network. Many industrial control systems, however, operate in degraded environments at some point during their lifespan where network connections might be intermittent or unreliable or where the network connections have low bandwidth or high latency. In such environments, a centralized security server may be unavailable to authenticate and authorize a remotely-located network component depending on the status of the network.

Furthermore industrial control systems may require efficient execution of repetitive processes. Access control mechanisms that employ a separate authentication mechanism and a separate authorization mechanism thus increase the complexity of the access control procedure.

Therefore a need exists for improvements to authenticating and authorizing interconnected devices in industrial control systems.

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

To overcome limitations in the prior art described above, and to overcome other limitations that will be apparent upon reading and understanding the present specification, aspects described herein are directed towards systems and computer-implemented methods of authenticating and authorizing a device in an industrial control system using the same digital certificate.

A first aspect described herein provides a computer-implemented method of performing access control in an industrial control system. A first component of an industrial control system may be connected to a second component of the industrial control system. A digital certificate may be generated for the first component that includes both authentication information and authorization information associated with the first component. The first component may transmit the digital certificate to the second component, and the second component may extract the authorization information from the digital certificate. The second component may identify a set of access rights based on the authorization information extracted and authorize the first component to access the second component based on the set of access rights identified.

A second aspect described herein provides an industrial control system. The industrial control system may include a first industrial device, a second industrial device, and a digital certificate associated with the first industrial device. The digital certificate includes both authentication information and authorization information for the first industrial device. The second industrial device may be configured to receive the digital certificate from the first industrial device, extract the authorization information from the digital certificate, and authorize the first industrial device to access the second industrial device based on the authorization information extracted.

A third aspect described herein provides a computer-implemented method of performing access control. A digital certificate may be generated for a first device that includes both authentication information and authorization information associated with the first device. A connection may be established between the first device and the second device, and the digital certificate may be transmitted between the first device and the second device. The first device may be authenticated based on the authentication information of the digital certificate. The first device may also be authorized to access the second device based on the authorization information of the digital certificate.

The components and devices may be industrial devices of the industrial control system such as a programmable logic controller (PLC), a programmable automation controller (PAC), a remote telemetry unit, an industrial machine, an industrial control device, an industrial monitoring device, an industrial sensor device, a data warehouse device, and a human-machine interface (HMI) device.

The authorization information may be obfuscated in the digital certificate and include a role indicator or a set of access rights. The digital certificate may be configured to store the authorization information in an extension field of the digital certificate. The digital certificate may be structured according to the X.509v3 standard. The extension field of the digital certificate may be configured to include an object identifier that is associated with an entity that maintains the industrial control system. A device that receives the digital certificate may include a parser that is configured to parse the digital certificate using the object identifier in order to extract the authorization information. The set of access rights may be identified by mapping the authorization information to the set of access rights.

A certificate issuer may be configured to generate the digital certificate based on the authentication and authorization information associated with a device of an industrial network. The certificate issuer may include an authorization specification interface configured to receive the authorization information associated with the device.

These and additional aspects will be appreciated with the benefit of the disclosures discussed in further detail below.

### BRIEF DESCRIPTION OF THE DRAWINGS

A more complete understanding of aspects described herein and the advantages thereof may be acquired by referring to the following description in consideration of the accompanying drawings, in which like reference numbers indicate like features, and wherein:

FIG. 1 is an example of an implementation of an industrial control system in accordance with aspect described herein.

FIG. 2 is another example of an implementation of an industrial control system in accordance with aspects described herein.

FIG. 3 is an example of an implementation of a digital certificate in accordance with aspects described herein.

FIG. 4 is a flowchart of example method steps for authenticating and authorizing a device in an industrial control system in accordance with aspects described herein.

### DETAILED DESCRIPTION

In the following description of the various embodiments, reference is made to the accompanying drawings identified above and which form a part hereof, and in which is shown by way of illustration various embodiments in which aspects described herein may be practiced. It is to be understood that other embodiments may be utilized and structural and functional modifications may be made without departing from the scope described herein. Various aspects are capable of other embodiments and of being practiced or being carried out in various different ways.

As a general introduction to the subject matter described in more detail below, aspects described herein are directed towards systems and computer-implemented methods of authenticating and authorizing a device in an industrial control system using the same digital certificate. As described in further detail below, devices of an industrial control system are each provided with a digital certificate that includes both authentication (AuthN) information and authorization (AuthZ) information. A device thus carries with itself certified AuthN and AuthZ information. The device may thus transmit its digital certificate containing AuthN and AuthZ information to another device in the industrial control system when requesting access to that device.

For convenience the following terminology is adopted herein. The device that requests access to another device in an industrial control system is referred to as the requesting device. The device the requesting device requests access to is referred to as the target device.

Including AuthN and AuthZ information in the same digital certificate provides various advantages in an industrial control system. One advantage is the ability to transmit certified AuthN and AuthZ information in a single, tamper-resistant digital object. For industrial control systems operating in degraded environments with intermittent, unreliable, and low-bandwidth networks, a requesting device may advantageously transmit the AuthN and AuthZ information to a target device in a single network communication. In addition, a digital certificate that includes both AuthN and AuthZ information in a single digital certificate has a relatively smaller file size than two digital certificates that store the same AuthN and AuthZ information separately.

Another advantage is the ability to enforce security policies locally without the need for a centralized security server. This advantageously allows local systems and local components of an industrial control system to continue to operate where the connection to a control center is interrupted or otherwise unavailable. Consider, for example, an industrial control system that includes a control center in signal communication with multiple field stations distributed across a wide geographic area. A new device deployed locally to one of the field stations may advantageously be authenticated and authorized to access the other components at that field station—even if the field station is cutoff from the control center—by providing a digital certificate that includes both AuthN and AuthZ information.

A further advantage is the elimination of the need to identify and configure access privileges for a new device at a target device (e.g., in an access control list), before the new device requests access to the target device. Since the new device carries with it certified AuthN and AuthZ information, the target device may provision access rights to the new device even if the target device does not recognize the new device.

An additional advantage is the elimination of the need to store and validate (e.g., through a central server) dedicate role information for each individual device that may connect to a target device. Additional advantages will be appreciated upon review of the disclosures provided in further detail below.

It is to be understood that the phraseology and terminology used herein are for the purpose of description and should not be regarded as limiting. Rather, the phrases and terms used herein are to be given their broadest interpretation and meaning The use of “including” and “comprising” and variations thereof is meant to encompass the items listed thereafter and equivalents thereof as well as additional items and equivalents thereof. The use of the terms “mounted,” “connected,” “coupled,” “positioned,” “engaged” and similar terms, is meant to include both direct and indirect mounting, connecting, coupling, positioning and engaging. Furthermore a “set” of elements as used herein is meant to include one or more elements. Moreover non-transitory computer-readable media refers to all computer-readable media with the sole exception being a transitory propagating signal.

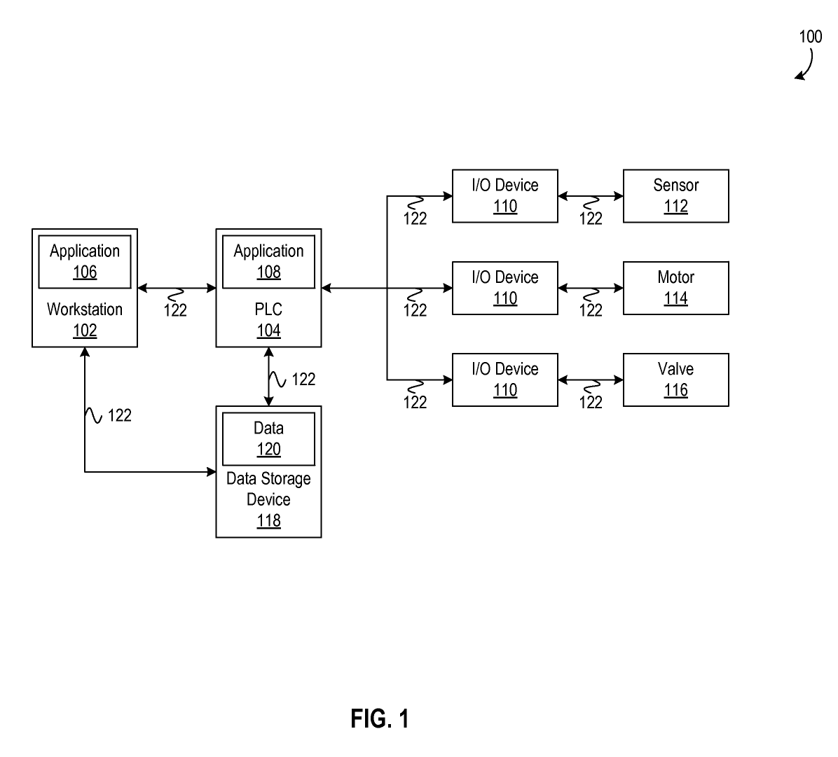

Referring now to FIG. 1, an example of an implementation of an industrial control system 100 is shown. As described above, an industrial control system may include multiple interconnected industrial devices. As also described above, industrial devices may include devices used to control, monitor, and coordinate operation of an industrial system, industrial facility, industrial process, industrial device, industrial machine, and the like. Industrial devices include “intelligent” (i.e., processor-based) control or monitoring devices that are configured to receive input from industrial devices (e.g., sensors) and issue commands to other industrial devices (e.g., industrial equipment). Industrial devices include devices that only provide output (e.g., some types of sensors), devices that only receive input (e.g., some types of industrial equipment), and devices that both receive input and provide output (e.g., I/O devices such as intelligent control devices). Industrial devices also include specially-configured computing devices having control software or monitoring software and computing devices that are otherwise configured with instructions for controlling or monitoring other industrial devices in the industrial control system. Industrial devices also include data collection devices and data storage devices. An industrial device may also include one or more industrial devices as sub-components.

Examples of industrial devices include programmable logic controllers (PLCs), remote terminal (or telemetry) units (RTUs), process (or programmable) automation controllers (PACs), human-machine interface (HMI) devices, and supervisory computing devices. With respect to industrial equipment, industrial devices include variable-speed drives, motor soft starters, motor controllers, power meters, control valves, protection relays, switches, pumps, valves, actuators, and the like. With respect to industrial sensors, industrial devices include pressure sensors, flow sensors, electrical sensors, weight sensors, temperature sensors, humidity sensors, moisture sensors, magnetic sensors, vibration sensors, and other types of sensors used in industrial control systems. Other types of industrial devices include, for example, industrial gateways, industrial field devices, industrial measuring devices, and devices of industrial safety integrated systems.

As shown by way of example in FIG. 1, the industrial control system 100 includes a workstation 102 coupled to a PLC 104. The workstation 102 may be a computing device that comprises one or more processors (not shown), one or more applications such as application 106, and a user interface (not shown) that allow a user to configure, alter, control, or monitor the operation of the PLC 104. The user interface may include input and output devices (e.g., a keyboard, mouse, touchscreen, touch pad, stylus, display screen, speakers, and the like) respectively configured to receive input from a user and provide output to the user. The PLC 104 may be any of various types of commercially available PLCs such as the Modicon™ Quantum™ PLC available from Schneider Electric. As seen in FIG. 1, the PLC 104 may also include one or more applications such as application 108 that control the operation of the industrial control system 100 and receive inputs from the various devices of the system.

The PLC 104, in this example, is in signal communication with multiple I/O devices 110 for the purpose of monitoring and controlling various devices such as actuations and sensors of the industrial control system 100. The I/O devices 110 in FIG. 1 are respectively in signal communication with a sensor 112, a motor 114, and a valve 116. In some industrial control systems an I/O device may be in signal communication with multiple devices, e.g., multiple sensors.

The workstation 102 and the PLC 104, in this example, are each also in signal communication with a data storage device 118. The data storage device 118 may store data 120 collected by the I/O devices 110 and transmitted to the PLC 104. In some industrial control systems, the I/O devices 110 themselves may be coupled to a data storage device to store the data collected from other devices in the industrial control system.

As seen in FIG. 1, the components of the industrial control system 100 are in signal communication via various communication links 122. The communication links 122 may be direct connections between devices of the industrial control system 100. For example, the I/O devices 110 may each be directly connected to the sensor 112, motor 114, and valve 116 respectively. The communication links 122 may also be links in a network such as, for example, a local area network (LAN), a wide area network (WAN) such as the Internet. As another example, the PLC 104 may be connected to the I/O devices 110 through a backplane interconnection. Accordingly the communication links 122 may include both wired and wireless communication links. In addition the components of the industrial control system 100 may, for example, communicate via an industrial Ethernet and operate, for example, according to the EtherNet/IP protocol (EtherNet/Industrial Process) or MODBUS protocol.

The industrial control system 100 shown in FIG. 1 is provided for illustrative purposes. It will be appreciated with the benefit of this disclosure that other implementations of industrial control systems may include additional or alternative industrial control elements and exhibit additional or alternative configurations. As described above, the industrial control system 100 seen in FIG. 1—as well as other industrial control systems—would benefit from an authentication and authorization architecture where AuthN and AuthZ information is provided in the same digital certificate.

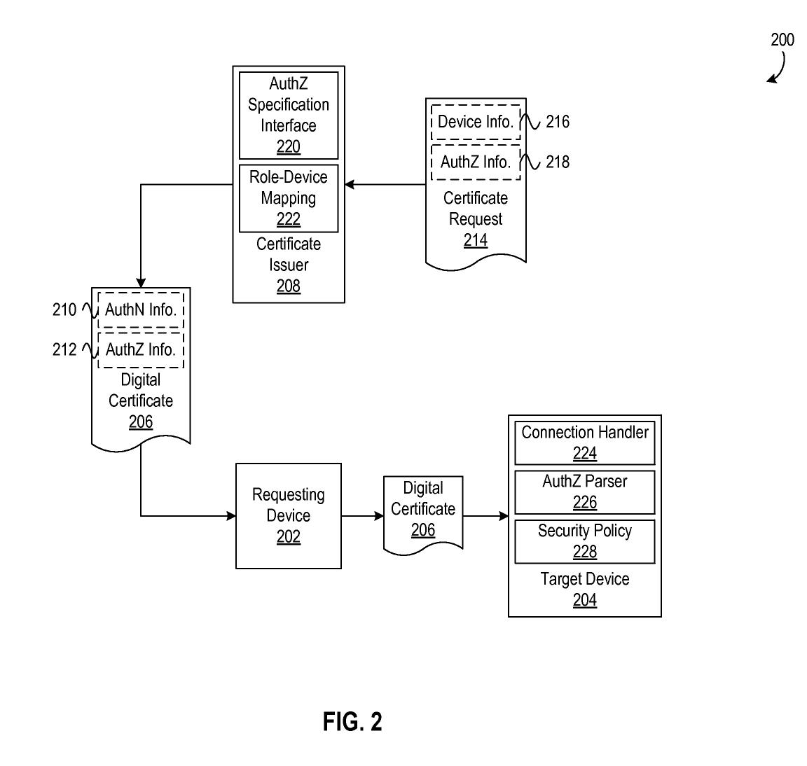

In FIG. 2, another example of an implementation of an industrial control system 200 in accordance with aspects of the present disclosure is shown. As seen in FIG. 2, a requesting device 202 is in signal communication with a target device 204. The requesting device 202 may connect to the target device 204 and, once connected, submit access requests to the target device.

Access requests may include data requests to retrieve data stored at the target device 204 as well as command requests to invoke functionality the target device is configured to perform. As described above, the requesting device 202 may transmit a digital certificate 206 to the target device 204, which the target device uses to authenticate and authorize the requesting device.

For authentication, the industrial control system 200, in this example, relies on a public key infrastructure (PKI) which binds a public key associated with the requesting device 202 with the identity of the requesting device through the digital certificate 206. In a PKI, a certificate issuer—such as certificate issuer 208 in FIG. 2—issues the digital certificate 206 that binds the identity of the requesting device 202 to its public key. The certificate issuer 208 may also be referred to as a certificate authority (CA). The certificate issuer 208 digitally signs the digital certificate 206 with its own private key to certify the identity of the requesting device 202 and provides the digital certificate to the requesting device for use when communicating with other devices in the industrial control system 200. The certificate issuer 208 may be a component of the industrial control system 200, as shown by way of example in FIG. 2, in which case the digital certificate 206 may be a self-signed certificate signed by the entity that maintains the industrial control system. In other example implementations, however, the certificate issuer 208 may be a third-party CA.

As described above, authentication and authorization is performed for the requesting device 202 in the industrial control system 200 using the same digital certificate 206. Accordingly the digital certificate 206 includes both AuthN information 210 and AuthZ information 212 as seen in FIG. 2. The certificate issuer 208 may be configured to create respective digital certificates for multiple devices in the industrial control system 200. The certificate issuer 208 may create digital certificates in response to receipt of certificate requests such as certificate request 214. In some example implementation, the certificate issuer 208 may receive the certificate request 214 from an individual associated with the entity that maintains the industrial control system, e.g., a security administrator. In other example implementations, the certificate issuer 208 may receive a certificate request from the device the digital certificate is to be created for. A certificate issuer may also be configured to receive certificate requests from both an individual and a device of an industrial control system.

As shown by way of example in FIG. 2, the certificate request 214 may include device information 216. The device information 216 may be included in or used to generate the AuthN information 210 of the digital certificate 206. The device information 216 may include information that identifies, alone or in combination, a device of the industrial control system. Accordingly the device information 216 may include a device name, a device model number, a device serial number, a media access control (MAC) address, and the like. The device information 216 may also include a public key generated for the requesting device 202. The AuthN information 210 may, in turn, include some or all of the device information 216 or include an identifier that is based on a combination of some or all of the device information, e.g., a hash value of an n-tuple of the device information. The certificate issuer 208 may, in some example implementations, be configured to generate the AuthN information 210 based on the device information 216 received in the certificate request 214. The AuthN information 210 may uniquely identify each device of the industrial control system 200 or, alternatively, may simply identify a device type or device category.

As also shown by way of example in FIG. 2, the certificate request 214 may additionally include AuthZ information 218. Submitting a certificate request with specified AuthZ information may be part of the process of enrolling a new device in an industrial control system. The AuthZ information 218 in the certificate request 214 may correspond to the AuthZ information 212 in the digital certificate 206 issued by the certificate issuer 208. In some example implementations, the AuthZ information 212 in the digital certificate 206 may be the same as the AuthZ information 218 of the certificate request. In other example implementations, the AuthZ information 212 in the digital certificate 206 may be based on the AuthZ information 218 in the certificate request 214. As described below, the AuthZ information 218 may be the specified role for a device or information employed to perform a lookup of the appropriate role for the device. To receive the AuthZ information 218, the certificate issuer 208, in this example, includes an authorization specification interface 220. The AuthZ specification interface 220 may enable an individual to specify the AuthZ information 218. The AuthZ specification interface 220 may, additionally or alternatively, enable a device of the industrial control system 200 to specify the AuthZ information 218. The AuthZ specification interface 220 may include, e.g., a web-based interface at which an individual may specify the AuthZ information 218. Additionally or alternatively, the AuthZ specification interface 220 may include an application programming interface (API) having functionality a device may invoke to specify the AuthZ information 218. Various protocols may be selectively employed to submit the certificate request 214, e.g., the Simple Certificate Enrollment Protocol (SCEP) or the Certificate Management Protocol (CMP).

In some example implementations, a certificate issuer may be configured to automatically obtain the AuthZ information 212 for the digital certificate 206 based on the device information received. In these implementations, a certificate request may only include the device information, and the certificate issuer may perform a lookup of AuthZ information using the device information or otherwise map the device information to corresponding AuthZ information. As shown by way of example in FIG. 2, the certificate issuer 208 includes a role-device mapping 222 that includes multiple entries that pair device types with AuthZ information 212. As one example, a role-device mapping may pair AuthZ information with a device model number. Upon receipt of a certificate request, the certificate issuer 208 may extract the device information 216 and perform a lookup in the role-device mapping 222 using the device information extracted. The certificate issuer 208 may then include the AuthZ information paired with the device information 216 in the digital certificate 206 as the AuthZ information 212. In FIG. 2, the role-device mapping 222 is stored locally at the certificate issuer 208. The role-device mapping 222 may include In some example implementations, a data store located remotely relative to a certificate issuer may store the role-device mapping or other type of data repository that associates device information with corresponding AuthZ information. The certificate issuer 208 may thus alternatively retrieve the AuthZ information from the remote data store by submitting to the remote data store a query that includes information received in the certificate request, e.g., device information. Having retrieved the AuthZ information for the device (e.g., the appropriate role for the device), the certificate issuer 208 may enter or otherwise configure a new certificate for the device with the AuthZ information retrieved.

Having obtained the AuthN information 210 and the AuthZ information, the certificate issuer may generate the digital certificate 206 that includes both the AuthN and the AuthZ information. The AuthZ information may include, for example, a role indicator that identifies a role associated with the corresponding device of the industrial control system 200. The particular configuration of the role indicator may depend on the manner in which an industrial control system identifies roles. In some example implementations, the role indicator may simply identify the role of the device, e.g., “Administrator,” “Operator,” etc. The role identified in the AuthZ information 212 may then be mapped to a set of access rights as discussed in further detail below. In some example implementations, the AuthZ information 212 may include the access rights themselves, e.g., a set of operations the device associated with the digital certificate 206 is permitted to perform at other devices in the industrial control system 200. In some example implementations, the AuthZ information 212 may include both a role indicator and a set of access rights.

Having received its digital certificate 206, the requesting device 202 may establish a connection with the target device 204. As seen in FIG. 2, the target device 204, in this example, includes a connection handler 224, an AuthZ parser 226, and a security policy 228. The target device 204, in this example, utilizes the connection handler 224 to facilitate establishing connections with other devices of the industrial control system 200, utilizes the AuthZ parser 226 to parse and extract the AuthZ information 212 from the digital certificate 206 received, and utilizes the security policy 228 to determine the access rights of the requesting device 202 based on the AuthZ information 212 extracted.

In some example implementations, the devices of an industrial control system 200 may use the Transmission Control Protocol (TCP) to establish a connection. To secure the communications exchanged over a TCP connection, the requesting device 202 and the target device 204 may employ Transport Layer Security (TLS). During a connection handshake, the requesting device 202 and the target device 204 may exchange digital certificates. The connection protocol of the target device 204 may be configured to extract the AuthZ information as part of the connection process. Accordingly, existing connection protocols implemented by devices in an industrial control system may be updated to include this extraction step. It will be noted that TCP and TLS are described by way of example only. Other implementations may selectively employ alternative transmission and security protocols that are suitable to establish connections between devices in an industrial network, initiate a communication session, and exchange digital certificates.

As described above, the target device 204 utilizes the digital certificate 206 to both authenticate and authorize the requesting device 202 based on the AuthN information 210 and the AuthZ information 212 included therein. Having extracted the AuthZ information 212 from the digital certificate 206 received using the AuthZ parser 226, the target device 204 may apply the security policy 228 to determine what access rights are associated with the AuthZ information. The security policy 228 may, for example, pair a set of access rights with a corresponding role. The target device 204 may thus match a role indicator extracted from the digital certificate 206 to a role listed in the security policy 228. The security policy 228 may depend on and be configured by the entity that maintains the industrial control system 200. In some example implementations, the AuthZ information 218 provided to the certificate issuer 208 may correspond to authorization information (e.g., role types) identified in the security policies maintained by the devices on the industrial control system 200. In this way, AuthZ information pre-configured at the devices of an industrial control system may advantageously be leveraged when creating digital certificates that include AuthZ information for devices of the industrial control system 200.

Having extracted the AuthZ information, the target device 204 may then provision the requesting device 202 with permissions corresponding to the access rights the security policy 228 associates with that role. In this way, the target device 204 may advantageously authorize the requesting device 202 locally. By including both AuthN information 210 and AuthZ information in the digital certificate 206, the identity of the requesting device 202 advantageously does not need to be distributed to the target device 204 before the requesting device first contacts the target device. In addition, the target device 204 may advantageously authorize the requesting device 202 without contacting a centralized security server.

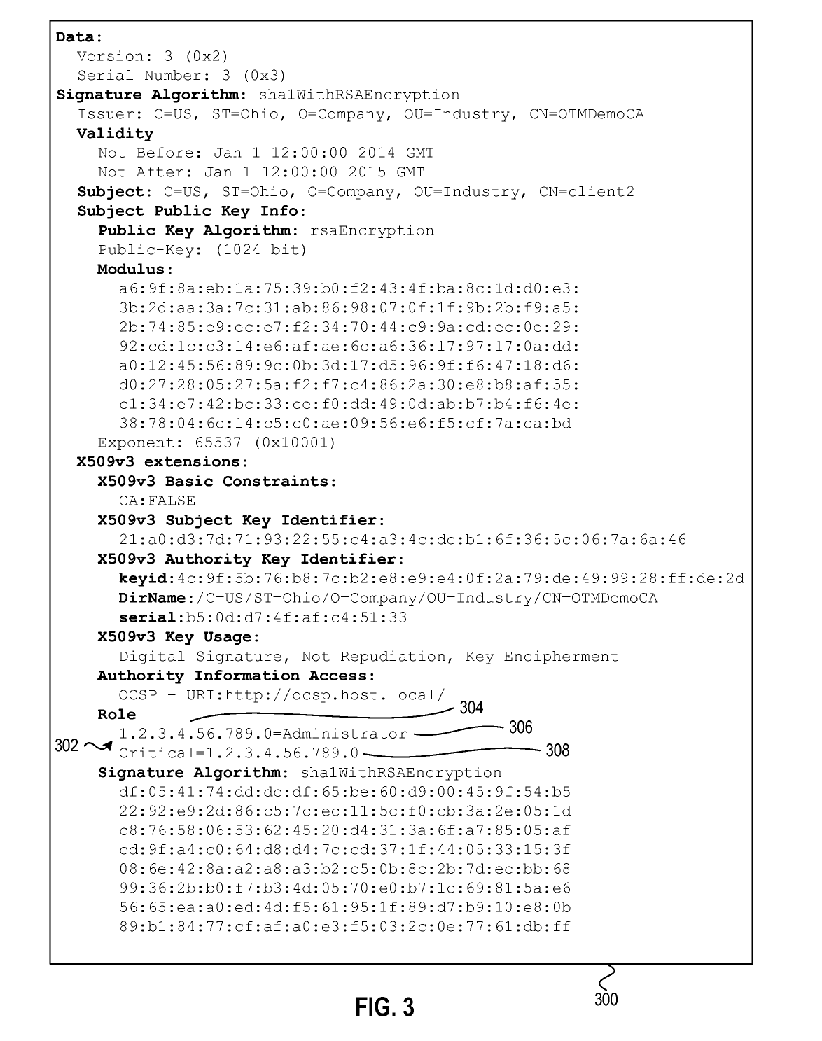

The digital certificate 206 may be, for example, based on the X.509 standard. Referring to FIG. 3, an example of an implementation of a digital certificate 300 in accordance with aspects of the present disclosure is shown. The digital certificate 300 in FIG. 3 is structured according to the X.509v3 standard. The X.509v3 standard specifies various fields both required and optional for a digital certificate. The X.509v3 standard also permits extensions for including additional information in a digital certificate. An extension field in an X.509v3 digital certificate includes an Object Identifier (OID), a corresponding extension value, and a critical indicator. The critical indicator indicates whether the extension is critical or non-critical. Systems that process X.509v3digital certificates utilize the critical indicator to determine whether the digital certificate may be accepted or must be rejected depending on whether the extension or its value is recognized or can be processed.

As seen in FIG. 3, the digital certificate 300, in this example, includes AuthZ information 302 as one of the extensions of the digital certificate. As seen in FIG. 3, the AuthZ information 302, in this example, includes an OID 304 paired with a role indicator 306 and a critical indicator 308 identifying the OID. In the digital certificate 300 of FIG. 3, the role indicator 306 is included in the digital certificate as plaintext, e.g., “Administrator.” In some example implementations, however, the role indicator 306 may be obfuscated to keep secret the different role types implemented at an industrial control system. As an example, a digital certificate may specify an administrator-like role using an obfuscated role indicator such as “22482-9311” which would not communicate to a third-party that obtained the digital certificate the types of roles implemented at the industrial control system. A target device may be configured to extract an obfuscated role indicator from a digital certificate and map the obfuscated role indicator to a plaintext role indicator. The target device may then perform a lookup of the access rights associated with the plaintext role indicator in a security policy (e.g., security policy 228 in FIG. 2). A security policy may, alternatively, map the obfuscated role indicator itself to a set of access right.

In some example implementations, the OID 304 may be a unique identifier associated with the entity that maintains the industrial control system that utilizes the digital certificate 300. The OID 304 and the corresponding role indicator 306 may be, e.g., a UTF-8 string although other types of character encodings may be selectively employed. Pairing the role indicator 306 with a unique identifier in the OID 304 advantageously allows an AuthZ parser (e.g., AuthZ parser 226 in FIG. 2) to locate the AuthZ information 302 relatively easily. An AuthZ parser may, for example, be configured to search for the particular OID 304 associated with the entity that maintains the industrial control system and parse the role indicator 306 paired with that OID. Although the critical indicator 308 is shown to be separate from the role indicator 306 in FIG. 3, the ASN1 format permits the OID to be paired with both the role indicator and the critical indicator (e.g., “1 .2 .3 .4 .56.789.0=Critical, Administrator).

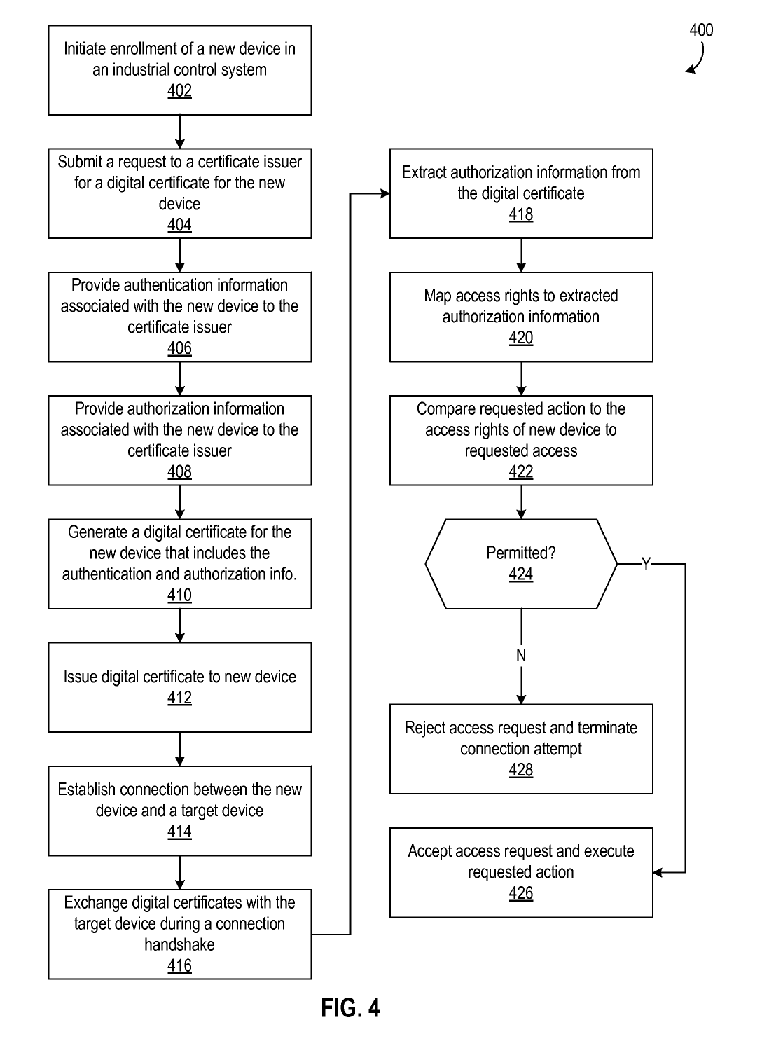

Referring now to FIG. 4, a flowchart 400 of example method steps for authenticating and authorizing a device in an industrial control system is shown. Enrollment of a new device in an industrial control system may be initiated (block 402). Enrolling a new device in the industrial control system may include, e.g., connecting the new device to a network maintained by the industrial control system, configuring the new device with appropriate configuration settings, generating a public key and a corresponding private key for the new device, and determining the appropriate role for the new device in the industrial control system. A request for a digital certificate for the new device may be submitted to a certificate issuer (block 404). Along with or subsequent to the certificate request, AuthN information associated with the new device may be provided to the certificate issuer (block 406). As described above, AuthN information may include a public key generated for the new device and information that identifies the new device. In addition, AuthZ information associated with the new device may be provided to the certificate issuer (block 408) along with or subsequent to the certificate request. As also described above, the AuthZ information may include a role indicator that indicates the role that has been selected for the new device.

The certificate issuer may then generate a new digital certificate (e.g., an X.509 certificate) for the new device that includes the AuthN information and the AuthZ information received (block 410). Having generated the digital certificate, the certificate issuer may issue the digital certificate to the new device (block 412), and the new device may store the digital certificate for use when communicating with other devices in the industrial control system. Having obtained the digital certificate, the new device is equipped to secure communications exchanged with those other devices. The new device may establish a connection (e.g., a TCP connection) with a target device in the industrial control system (block 414), secure the connection using a security protocol (e.g., TLS), and exchange digital certificates with the target device during the connection handshake (block 416). During the connection handshake, the new device may provide its digital certificate to the target device and receive a digital certificate from the target device. Likewise the target device may provide its digital certificate to the new device and receive a digital certificate from the new device.

The target device may authenticate the new device based on the AuthN information received in the digital certificate, e.g., the public key associated with the device and the digital signature of the certificate issuer. In addition, the target device may extract the AuthZ information from the digital certificate (block 418), and map a set of access rights to the AuthZ information extracted (block 420), e.g., using a security policy. The target device may then compare the access rights of the new device to access requested by the new device (block 422). Such requests may include, e.g., requests to retrieve data, issue commands, invoke functionality, etc. The target device may determine whether the provisioned permissions permit execution of the requested access. If the access request is permitted (block 424:Y), then the target device may accept the access request and execute the requested action (block 428). If, however, the access request is not permitted, then the target device may reject the access request and terminate the connection attempt (block 430). Terminating the connection attempt may be part of an access rejected action executed when the access rights of the new device do not permit the new device to perform a requested action. An access rejected action may also include transmission of a refusal message to the new device.

It will be appreciated that the steps described above and illustrated in FIG. 4 are provided by way of example only. Other approaches for authenticating and authorizing a device in an industrial control system using the same digital certificate may include additional or alternative steps and perform those steps in an alternative sequence. These alternative approaches, however, are intended to fall within the scope of the claimed subject matter below.

Furthermore the disclosures above describe authenticating and authorizing devices in an industrial control system using the same digital certificate. As described above, however, a device in an industrial control system may be configured with instruction sets, functional modules, software applications, and the like. The techniques for authenticating and authorizing devices in an industrial control system using the same digital certificate may likewise be employed to authenticate and authorize, e.g., software applications installed at devices in an industrial control system using the same digital certificate. In particular, a certificate issuer may generate a digital certificate for a software application that includes both AuthN and AuthZ information, and that digital certificate may be stored at the device where the software application resides. The software application may thus provide the digital certificate to other software applications or devices of the industrial control system, and that digital certificate may advantageously be utilized to both authenticate and authorize the software application. Additional and alternative implementations will be appreciated with the benefit of this disclosure.

Moreover the techniques described herein for authenticating and authorizing devices using the same digital certificate may be employed in alternative contexts beyond industrial control systems. The techniques described herein may also be employed to authenticate and authorize personal devices in a cloud-based computing environment as well as corporate devices in enterprise-wide computing systems. The techniques described herein may also be employed to authenticate and authorize personal devices accessing third-party computing systems and third-party devices (and vice versa).

Although the subject matter has been described in language specific to structural features and/or methodological acts, it is to be understood that the subject matter defined in the appended claims is not necessarily limited to the specific features or acts described above. Rather, the specific features and acts described above are described as example implementations of the following claims.

What is claimed is:

1. A computer-implemented method of performing access control in an industrial control system comprising:
connecting a first component of an industrial control system to a second component of the industrial control system;
generating a digital certificate for the first component that includes both authentication information and authorization information associated with the first component;
transmitting the digital certificate from the first component to the second component;
extracting the authorization information from the digital certificate at the second component;
identifying, at the second component, a set of access rights based on the authorization information extracted; and
authorizing the first component to access the second component based on the set of access rights identified.

2. The computer-implemented method of claim 1 wherein:
the first component is a first industrial device of the industrial control system; and
the second component is a second industrial device of the industrial control system.

3. The computer-implemented method of claim 1 wherein:
generating the digital certificate includes storing the authorization information in an extension field of the digital certificate.

4. The computer-implemented method of claim 3 wherein:
storing the authorization information in the extension field of the digital certificate includes configuring an object identifier (OID) of the extension field to include a unique identifier that is associated with an entity that maintains the industrial control system.

5. The computer-implemented method of claim 4 wherein:
extracting the authorization information from the digital certificate includes parsing the digital certificate using the unique identifier.

6. The computer-implemented method of claim 3 wherein:
the digital certificate is structured according to the X.509v3 standard.

7. The computer-implemented method of claim 3 wherein:
the authorization information comprises a role indicator.

8. The computer-implemented method of claim 7 wherein:
the role indicator is obfuscated in the digital certificate.

9. The computer-implemented method of claim 7 wherein:
identifying the set of access rights includes mapping the role indicator to the set of access rights.

10. The computer-implemented method of claim 1 further comprising:
specifying the authorization information to a certificate issuer via an authorization specification interface of the certificate issuer.

11. An industrial control system comprising:
a first industrial device;
a digital certificate comprising authentication information and authorization information associated with the first industrial device; and
a second industrial device configured to
receive the digital certificate from the first industrial device,
extract the authorization information from the digital certificate, and
authorize the first industrial device to access the second industrial device based on the authorization information extracted.

12. The industrial control system of claim 11 wherein:
the first industrial device and the second industrial device are selected from the group consisting of
a programmable logic controller (PLC),
a programmable automation controller (PAC),
a remote telemetry unit,
an industrial machine,
an industrial control device,
an industrial monitoring device,
an industrial sensor device,
a data warehouse device, and
a human-machine interface (HMI) device.

13. The industrial control system of claim 11 further comprising:
a certificate issuer configured to generate the digital certificate for the first industrial device using the authentication information and the authorization information associated with the first industrial device.

14. The industrial control system of claim 13 wherein:
the certificate issuer comprises an authorization specification interface configured to receive the authorization information associated with the first industrial device.

15. The industrial control system of claim 13 wherein:
the certificate issuer is configured to automatically obtain the authorization information for the first industrial device based on device information associated with the first industrial device.

16. The industrial control system of claim 11 wherein:
the second industrial device comprises a parser configured to parse the digital certificate in order to extract the authorization information from the digital certificate.

17. The industrial control system of claim 11 wherein:
the digital certificate is structured to locate the authorization information in an extension field; and
the authorization information comprises a role indicator.

18. The industrial control system of claim 11 wherein:
the authorization information comprises a set of access rights for the first industrial device.

19. A computer-implemented method of performing access control comprising:
generating a digital certificate for a first device that includes authentication information and authorization information associated with the first device;
establishing a connection between the first device and a second device;
transmitting the digital certificate from the first device to the second device;
authenticating the first device based on the authentication information of the digital certificate; and
authorizing the first device to access the second device based on the authorization information of the digital certificate.

20. The computer-implemented method of claim 19 wherein:
the digital certificate is structured to locate the authorization information in an extension field; and
the authorization information comprises a role indicator.
